(19) United States
(12) Patent Application Publication
(10) Pub. No.: US 2021/0252758 A1
(43) Pub. Date: Aug. 19, 2021

(54) Hopper for Injection Molding Machine

(71) Applicant: Halkey-Roberts Corporation, St. Petersburg, FL (US)

(72) Inventors: Dennis Glen Wall, Clearwater, FL (US); Ismael Torres, Land O Lakes, FL (US)

(21) Appl. No.: 17/177,439

(22) Filed: Feb. 17, 2021

Related U.S. Application Data
(60) Provisional application No. 62/977,527, filed on Feb. 17, 2020.

(51) Int. Cl. B29C 45/18

(52) U.S. Cl. CPC B29C 45/1816; B29C 2045/1833

(57) ABSTRACT

A hopper for feeding previously-mixed virgin and crushed plastic materials into the throat of a barrel of an injection unit of a plastic injection molding machine, the hopper comprising a rotating auger extending longitudinally preferably in the center of the hopper from an upper area to a lower area within the hopper. The rotating auger rotates in the same direction as the flights of the auger such that the auger's flights continuously lift up the materials from the bottommost area of the hopper to an upper area of the hopper, thereby minimizing the coagulation of the materials in the lower areas of the hopper.

### CROSS-REFERENCE TO RELATED APPLICATIONS

This application claims the benefit of provisional patent application, Ser. No. 62/977,527, filed Feb. 17, 2020, the disclosure of which is hereby incorporated by reference herein.

### BACKGROUND OF THE INVENTION

### Field of the Invention

This invention relates to plastic injection molding machines. More particularly, this invention relates to hoppers for receiving virgin plastic material and crushed material and feeding such materials into the throat of the barrel of the plastic injection-molding machine.

### Description of the Background Art

Presently there exist many types of plastic injection molding machines manufactured by a variety of companies such as, to name a few, Arburg, Cincinnati Milacron, Engel, Husky, JSW (Japan Steel Works), Krauss Maffei, Negri Bossi, Nigata, Nissei, Toshiba, Toyo, Van Dorn Demag, and Wittman Battenfeld. Injection molding machines may be broadly characterized by how they function—either electrically (e.g., servomotors) or hydraulically (e.g., hydraulic pumps) to close and open the platens of the mold. Hybrid machines may function both electrically and hydraulically. After molding, the parts and runners are removed from the mold manually or by a robotic arm.

Depending on the type of virgin polymer to be used and the manufacturer, there also exist many forms of plastics such as very small “pellets”, which may comprise rounded balls, potato-shaped (irregular or random shape that varies from one pellet to another), smashed ball or like a pill (like an aspirin) or small solid or hollow cylinders. The polymer pellets are sometimes referred to as “resin”. Plastic injection machines employ “mixers” that usually include four compartments—one for the virgin pellets, one for the crushed material from the runners and defective parts, one for the pigment and one for an additive, that are mixed together and then fed into a “hopper”.

Plastic injection molding machines typically include an injection unit, a clamping unit, a power unit and a control unit. The injection unit is the part of the machine that receives the materials from the hopper, melts them and injects them into the mold. The “throat” of the injection unit is located at the beginning of the “barrel” and has threaded holes that are used to mount the hopper that will serve to receive and introduce the materials—pellets, crushed material, pigment(s) and additive(s). The “barrel” of the injector unit is a metallic cylinder that contains a “screw” and through which the molten materials from the flow. The “nozzle” of the injector unit is located at the end of the barrel and it is where the molten materials exit the barrel. The nozzle is the part of the injection unit that joins with the clamping unit when it contacts the mold in what is known as the sprue. The screw of the injector unit is located inside of the barrel and has the shape of a giant screw that has a diameter that is basically the same as the inner diameter of the barrel. As the screw rotates, the molten materials from the hopper advance by virtue of being pushed by the threads of the screw to push the molten materials (i.e., injected) to the front and into the mold.

The clamping unit holds, opens and closes the mold and handles the moves (forward and backward) of the ejection mechanism to release the plastic parts from the mold cavities. An “ejector plate” mounted inside of the mold may be screwed with the machine ejector bars (to make it advance and recoil) or may be only pushed by the ejector bar to make it advance and it is recoiled by the action of springs inside of the mold. “Ejector Pins” are small metallic bars or rods that are attached to the ejector plate of the mold usually extending to the mold cavity and the runner. The ejector pins remove the part and the runner when the ejector bar of the machine moves forward.

As mentioned above most plastic injection machines include a “crusher” a/k/a “shredder” or “grinder” that crushes the runners and defective parts. Crushers comprise very sharp and strong blades to crush the plastic which then flows into a “crib” so that only the crushed plastic smaller than the holes in the crib may pass to the container in the bottom of the equipment. The crushed material is fed into the hopper machine either manually or automatically by a feeder system.

Unfortunately, however, as the crusher's blades start to lose their sharpness, a lot of fine crushed material (very small plastic particles) tends to be spongy and coagulates in the hopper, such that the flow of materials from the hopper into the throat is compromised. Sometimes the flow of materials from the hopper into the throat clogs the feed to such an extent that the hopper has to be emptied and cleaned out.

Therefore, it is an object of this invention to provide an improvement that overcomes the aforementioned inadequacies of the prior art devices and provides an improvement that is a significant contribution to the advancement of the plastic injection art.

Another object of this invention is to provide an improved hopper for feeding virgin and crushed materials into the throat of a barrel of a plastic injection unit of a plastic injection-molding machine.

Another object of this invention is to provide an improved hopper including a rotating auger that continually agitates the materials in the hopper to minimize the coagulation of the materials in the hopper.

Another object of this invention is to provide an improved hopper having a rotating auger that operates in the same direction of the flights of the auger such that the rotating auger continuously lifts up the material from the bottom of the hopper thereby minimizing the coagulation of the materials in the hopper.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises an improved hopper for feeding previously mixed virgin and crushed materials from the hopper into the throat of a barrel of an injection unit of a plastic injection-molding machine. More particularly, the hopper comprises a rotating auger extending longitudinally preferably in the center of the hopper from an upper area to a lower area within the hopper to agitate the materials in the hopper upwardly from the bottom of the hopper, thereby minimizing the coagulation of the materials in the hopper that might otherwise compromise the feeding of the materials into the throat of the barrel of the injection unit.

Preferably, the rotating auger operates in the same direction as the flights of the auger. Also preferably, the length of the auger extends to the bottom area of the hopper such that the auger's flights continuously lift up the materials from the bottommost area of the hopper to an upper area of the hopper, thereby minimizing the coagulation of the materials in the lower areas of the hopper.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a perspective view of the hopper of the invention, the body being shown in phantom to show the interior thereof, the hopper incorporating a rotating auger for fluffing materials in the hopper itself;

FIG. 2 is side elevational view of the hopper, the body being shown in phantom to show the interior thereof, showing the relative dimensions of the auger and its flights to lift the materials from a bottom area of the hopper upwardly to then fall off the flights into a top portion of the hopper; and

FIG. 3 is a partial enlarged side elevational view, partially in section, showing the screen and gasket covering the opened end of the hopper and FIG. 3A is an enlarged view showing the screen being retained by the gasket.

Similar reference characters refer to similar parts throughout the several views of the drawings.

### DETAILED DESCRIPTION OF THE PREFERRED EMBODIMENT

A typical plastic injection-molding machine comprises a mixer into which is fed virgin pellets of a desired plastic, crushed material of runners and defective parts that have been crushed in a crusher, any desired additives, if any, and any desired pigments, if any. The mixer mixes the materials to a generally homogenous admixture and feeds the admixture of materials into an input port of a hopper. Alternatively, the hopper may comprise a plurality of input ports for separate feeding of the re-pelletized material and the virgin pellets and/or colorant into the hopper via their respective input ports. The admixture of materials in the hopper feeds into the throat of a barrel that is heated to liquefy the admixture of materials being fed from the hopper. Upon closing opposing mold platens, the liquefied materials are then injected into the mold cavities and runners between the mated halves of the injection mold. After injection, the platens and their respective mold halves are separated and the molded parts and runners are removed manually from the mold or more typically by a robotic arm. Any defective parts and the runners are then fed into the mixer for recycling.

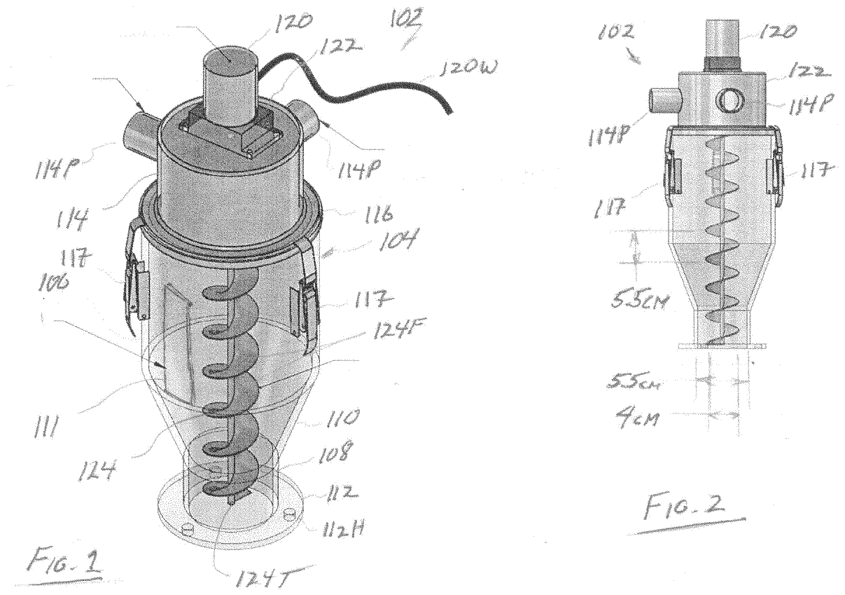

Referring to FIG. 1, the improved hopper 102 of the present invention comprises a body 104 having a generally circular cylindrical increased-diameter upper portion 106 and a generally circular-cylindrical reduced-diameter lower portion 108 fluidly connected together by a generally frustro-conical portion 110. Preferably, the longitudinal axes of the increased-diameter portion 106, reduced-diameter portion 108, frustro-conical portion 110 are coaxial with respect to one another. Also preferably, the increased-diameter portion 106, reduced-diameter portion 108, frustro-conical portion 110 and flange 112 are composed of welded stainless steel. A window 111 composed of a see-through material, may be positioned in the wall of the increased-diameter portion 106 to allow viewing of the materials in the hopper 102.

The lowermost rim of the reduced-diameter portion 108 includes a mounting flange 112 with holes 112H for connection to the throat of the barrel via threaded fasteners such as bolts (not shown).

A hollow plenum 114 is positioned about the uppermost rim of the increased-diameter portion 106. One or more input ports 114P are provided into the plenum 114 for receiving the supply of materials into the increased diameter portion 106 of the hopper 102. The plenum 114 is preferably removably connected to the uppermost rim 106R of the increased-diameter portion 106 by a corresponding flange 116 having an annular rim 116R on its underside to fit around the uppermost rim 106R of the increased-diameter portion 106 and secured in place by one or more (e.g., three equally-spaced) quick-release latches 117, thereby allowing the plenum 114 to be easily removed from the increased-diameter portion 114 for cleaning, etc.

A motor assembly comprising a motor 120, such as a direct current motor, is operatively connected to a gear box 120B that is mounted to the uppermost surface of the plenum 114 by mounting bolts 122. The drive axel 120A of the gear box 120B extends through a corresponding hole 114H in the uppermost surface of the plenum 114 longitudinally into the interior of the hopper 104, preferably centered relative to the longitudinal axis of the increased-diameter portion 106.

The uppermost or shank portion 124S of an auger 124 is fixedly connected to the drive axel 120A of the gear box 120B of the motor 120 by a shaft coupler 124C to rotate therewith. The auger 124 is thus suspended from the drive axel 120A of the motor 120 into the center of the hopper 104. The auger 124 rotates in the same direction as the drive axel 120A powered by the motor 120.

Preferably, the length of the auger 124 extends through the increased-diameter portion 106, through the frustro conical portion 110 and into the reduced-diameter portion 108 of the hopper 104. More preferably, the bottom tip 124Tof auger 124 does not extend into the throat of the barrel of the injection unit.

A circular annular sealing gasket 115 extends between the annular rim 116R of the flange 116 of the plenum 114 and the uppermost rim 106R of the increased-diameter portion 106. A circular screen 113, preferably composed of perforated stainless steel, extends from within an annular groove 115G extending radially inwardly from the gasket 115. The screen 113 includes a center hole 113H appreciably greater in diameter than the shank 113H to allow free-spinning of the shoulder portion 124S of the auger 124. Preferably, the screen 113 extends upwardly within the plenum 114 in a generally one-half toroidal cross-sectional configuration. The screen 113 serves as a final filter trapping too large of material from entering the hopper 124.

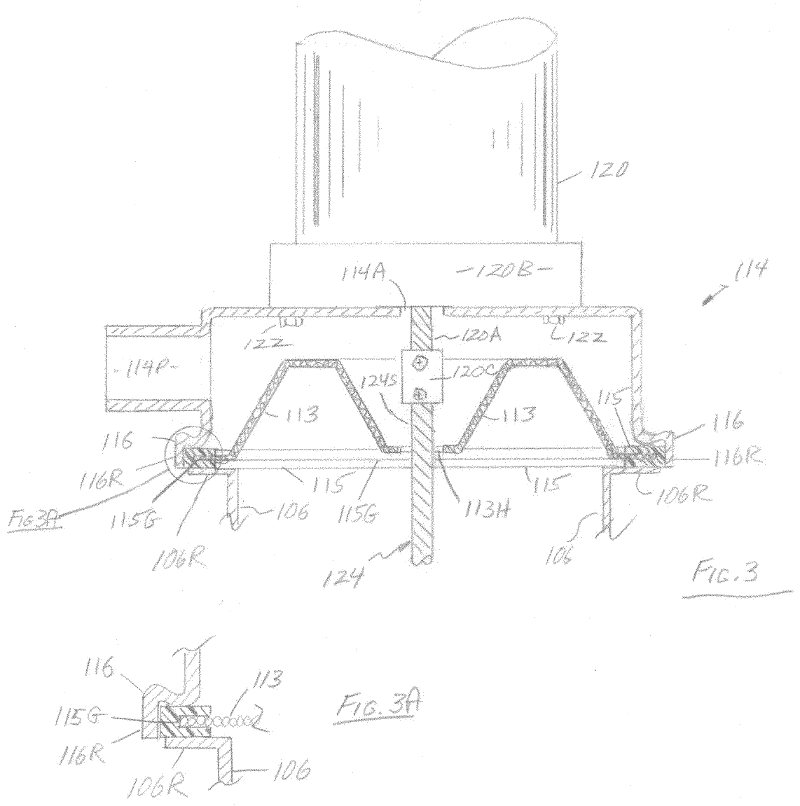

As better shown in FIG. 2, the best mode for implementing the invention is to provide an auger 124 comprising a continuous flight auger 124 proportionally having flights 124F with a pitch of about 5.5 cm and an overall diameter of about 4 cm used in conjunction with a lower diameter portion 108 having an inside diameter of about 5.5 cm.

Also preferably, the flights 124F are rotated by the motor 120 in a direction to lift the materials in the hopper 104 (i.e., flights extending clockwise are rotated clockwise, and visa versa) as opposed to pushing the materials toward the throat of the barrel.

The output electrical leads 120W of the motor 120 are connected to the control unit of the injection-molding machine and powered by DC current to drive the motor in the desired direction relative to the flights 124F of the auger 124. Preferably, the rotational speed of the auger 124 is about 25 rpm, which testing has found to be sufficiently fast to “fluff-up” the materials in the hopper 124 to move them upwardly from the bottom of the reduced diameter portion 108 toward the increased diameter portion but not too fast to otherwise impede the delivery of the materials into the throat of the barrel of the injection unit.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A hopper for connection to the throat of the barrel of an injection-molding machine, comprising in combination:
a body 104 having a mounting flange 112 for connection to the throat;
a plenum 114 having at least one input port 114P for receiving a supply of materials into the body 104;
a motor assembly mounted to said plenum 114, said motor assembly comprising a drive axel 120A extending through a corresponding hole 114H in the plenum 114; and
an auger 124 having flights 124F and a shank portion 124S, said shank portion 124S fixedly connected to said drive axel 120A of said motor assembly 120, said flights 124F of said auger 124 extending downwardly into said body 104 to lift the materials in the body 104 upwardly away from the throat.

2. The hopper as set forth in claim 1, wherein said body 104 comprises a generally cylindrical increased-diameter upper portion 106 and a generally cylindrical reduced-diameter lower portion 108 fluidly connected together by a generally frustro-conical portion 110.

3. The hopper as set forth in claim 2, wherein longitudinal axes of said increased-diameter portion 106, reduced-diameter portion 108, frustro-conical portion 110 are coaxial with respect to one another.

4. The hopper as set forth in claim 2, wherein said increased-diameter portion 106, reduced-diameter portion 108, frustro-conical portion 110 and flange 112 are composed of welded stainless steel.

5. The hopper as set forth in claim 1, wherein said body 104 further comprises a window 111 composed of a see-through material positioned in said increased-diameter portion 106 to allow viewing of the materials in the body 104.

6. The hopper as set forth in claim 1, wherein said plenum 114 is removably connected to an uppermost rim of the increased-diameter portion 106 by a corresponding flange 116 having an annular rim 116R on its underside to fit over an uppermost rim 106R of the increased-diameter portion 106.

7. The hopper as set forth in claim 1, wherein said plenum 114 is removably connected to said body 104 at least one quick-release latch 117.

8. The hopper as set forth in claim 1, wherein said shank portion 124S of said auger 124 is fixedly connected to said drive axel 120A of said motor 120 by a shaft coupler 124C to rotate therewith.

9. The hopper as set forth in claim 2, wherein said auger 124 is suspended from the drive axel 120A of the motor 120 into the body 104 and extends through said increased-diameter portion 106, through said frustro conical portion 110 and into said reduced-diameter portion 108 of the body 104.

10. The hopper as set forth in claim 1, wherein said auger 124 comprises a continuous flight auger.

11. The hopper as set forth in claim 1, further including an annular sealing gasket 115 positioned between said plenum 114 and said body 104.

12. The hopper as set forth in claim 11, further including a screen 113 extending from within an annular groove 115G extending radially inwardly from the gasket 115, said screen 113 including a center hole 113H.

13. The hopper as set forth in claim 12, wherein said screen 113 extends upwardly within said plenum 114 in a generally one-half toroidal cross-sectional configuration.

14. The hopper as set forth in claim 1, wherein an overall diameter of said auger 124 is appreciably less than an inside diameter of a lower diameter portion of said body 104.

15. The hopper as set forth in claim 14, wherein said overall diameter of said auger 124 comprises about 4 cm and said inside portion of said lower diameter portion of said body comprises about 5.5 cm.

16. The hopper as set forth in claim 1, wherein clockwise-extending flights of said auger 124 are rotated by said motor 120 in a clockwise direction to lift the materials in the body 104.

17. The hopper as set forth in claim 1, wherein said motor 120 rotates the auger 124 at about 25 rpm to “fluff-up” the materials in the hopper 124 to move them upwardly from the bottom of said body 204.

18. A method for fluffing material in a hopper having a discharge port, comprising the steps of:
positioning a continuous flight auger into the hopper, said auger having an overall diameter appreciably less than a diameter of the discharge port; and
rotating the auger in the direction of its flights to lift up the materials in the hopper to move them upwardly from the discharge port.
